(19) United States
(12) Patent Application Publication
(10) Pub. No.: US 2026/0039077 A1
(43) Pub. Date: Feb. 5, 2026

(54) DATA CABLE

(71) Applicant: XOOPAR LIMITED, New Territories (HK)

(72) Inventor: Ka Yin Tsui, New Territories (HK)

(21) Appl. No.: 18/918,144

(22) Filed: Oct. 17, 2024

(30) Foreign Application Priority Data
Aug. 5, 2024 (CN) 202421881252.5

(51) Int. Cl. H01R 31/06; H01B 11/00

(52) U.S. Cl. CPC H01R 31/065; H01B 11/00

(57) ABSTRACT

The present disclosure relates to a data cable, which can be used by users for short-distance connections, and can be further connected with different plugs based on short-distance connections. On the other hand, when the user uses the Type-C data cable for long-distance connection, the plug of the Type-C data cable can be plugged into the Type-C first socket of the present disclosure, and then further connection can be made through the second plug with different specifications, thus avoiding the user from repeatedly replacing the data cable for long-distance connection due to different plug use requirements. Users do not need to carry data cables with different plug types and different plug lengths when traveling. In this way, the product can adapt to different application requirements, improve the universality of the product, and also improve the convenience of use of the product.

### CROSS REFERENCE TO RELATED APPLICATIONS

The present application claims the benefit of Chinese Patent Application No. 202421881252.5 filed on August 5, 2024, the contents of which are incorporated herein by reference in their entirety.

### FIELD

The present disclosure relates to the field of data cables, particularly relating to data cable.

### BACKGROUND

With the rapid development of science and technology, especially the popularity of mobile devices and portable electronic products, the Type-C interface has quickly become the mainstream interface standard in the market with its high-speed data transmission, high-power charging, and convenience of forward and backward plugging. This transformation not only promotes the unification of electronic device interfaces, but also greatly improves the user experience. However, with the wide application of the Type-C interface, users' needs for charging and data transmission in different scenarios are increasingly diversified, and the traditional Type-C data cable with a single length and function has been difficult to meet all usage scenarios.

At present, the common Type-C data cables in the market are mainly divided into two types: one is a short data cable designed for portability, which is suitable for immediate needs such as mobile power supply charging, it is convenient to carry, but the application scenario is limited because of its short length; the other is the long data cable suitable for a fixed location, although this kind of data cable has a wide range of applications, in actual use, it is often necessary to switch different types of data cables according to different occasions or interface requirements, which not only increases the burden on users but also affects the convenience of use.

### SUMMARY

The technical problem to be solved by the present disclosure is to provide a data cable, which can solve the issues of poor application universality and low ease of use.

The present disclosure provides a data cable, comprising an input end, an output end, and a wire connecting the input end and the output end, the input end comprises a first outer housing, at least one Type-C first socket, at least one first plug, and a first circuit board, the Type-C first socket and each of the first plugs are electrically connected to the first circuit board respectively, the first outer housing covers the Type-C first socket, the at least one first plug, and the first circuit board respectively.

Preferably, the wire comprises a first line segment and a second line segment, the first input terminal of the first line segment is connected to the input end, and the second input terminal of the second line segment is connected to the first output terminal of the first line segment; and

the output end comprises a plurality of second plugs, at least two of the second plugs have different plug specifications, and each of the second plugs is connected to the second output terminal of the second line segment.

Preferably, the output end comprises at least one second plug which is connected to the wire, and the length of an effective connection path between any one of the first plugs and any one of the second plugs is 5 cm to 25 cm.

Preferably, the wire comprises a first line segment and at least one second line segment, and the second input terminal of each of the second line segments is connected to the first output terminal of the first line segment; and

the wire further comprises a switching member, the first output terminal is connected with the switching member, and each of the second input terminals is connected with the switching member.

Preferably, the switching member is provided with an intermediate input position and a plurality of intermediate output positions, the first output terminal is connected to the intermediate input position, and each of the second input terminals is connected to each of the intermediate output positions in one-to-one correspondence; and

the intermediate input position is respectively connected with each of the intermediate output positions in a straight line to form a plurality of intermediate paths, any of the intermediate paths can be independently used to form at least a part of the effective connection path.

Preferably, the length of the part of the first line segment exposed between the switching member and the first outer housing is 3 cm to 12 cm; and/or

the length of the part of at least one second line segment exposed between the switching member and the second plug is 3 cm to 12 cm.

Preferably, the length of each of the second line segments is equal; and/or

the length of the first line segment is equal to the length of each of the second line segments.

Preferably, the length of the first line segment is 4 cm to 14 cm; and/or

the length of at least one second line segments is 4 cm to 14 cm.

Preferably, the first plug comprises a USB plug and/or a Type-C plug; and/or

the Type-C first socket comprises a Type-C socket.

Preferably, the first outer housing is provided with a first output position and a plurality of first input positions, the first input terminal is connected to the first output position, the Type-C first socket and each of the first plugs are arranged in each of the first input positions in one-to-one correspondence;

the first output position is respectively connected with each of the first input positions in a straight line to form a plurality of first paths, and any one of the first paths can be independently used to form at least a part of the effective connection path.

Preferably, the first outer housing is provided with a seat hole, the Type-C first socket is arranged in the seat hole, two T-shaped positioning pieces are arranged in the first outer housing, and the two T-shaped positioning pieces respectively abut against the Type-C first socket from two opposite sides; and/or

the output end comprises a plurality of second plugs, at least two of the second plugs have different plug specifications, and each of the second plugs is arranged in the second output terminal of each of the second line segments in one-to-one correspondence.

The present disclosure has the following beneficial effects:

The present disclosure relates to a data cable, which can be used by users for short-distance connections, and can be further connected with different plugs based on short-distance connections. On the other hand, when the user uses the Type-C data cable for a long-distance connection, the plug of the Type-C data cable can be plugged into the Type-C first socket of the present disclosure, and then further connection can be made through the second plug with different specifications, thus preventing the user from repeatedly replacing the data cable for long-distance connection due to different plug use requirements. Users do not need to carry data cables with different plug types and different plug lengths when traveling.

In this way, the product can be adapted to different application requirements, which improves the universality of the product, and also improves the ease of use of the product.

### BRIEF DESCRIPTION OF THE DRAWINGS

The above and other objects, features, and advantages of this present disclosure will become more apparent by describing the exemplary embodiments of this present disclosure in more detail with the accompanying drawings, wherein, in the exemplary embodiments of this present disclosure, the same reference numerals usually represent the same parts.

FIG. 1 is a schematic structural diagram of a data cable in some embodiments of the present disclosure;

FIG. 2 is another schematic structural diagram of a data cable in some embodiments of the present disclosure;

FIG. 3 is a schematic structural diagram of the data cable shown in FIG. 2 from another view;

FIG. 4 is an explosion diagram of a data cable in some embodiments of the present disclosure;

FIG. 5 is a front view of a data cable in some embodiments of the present disclosure;

FIG. 6 is a schematic structural diagram of a data cable in other embodiments of the present disclosure; and

FIG. 7 is a schematic structural diagram of a part of the circuit of a data cable in some embodiments of the present disclosure.

### DETAILED DESCRIPTION

The embodiments of the present disclosure will be described in more detail concerning the attached drawings. Although the drawings show the embodiments of the present disclosure, it should be understood that the present disclosure can be realized in various forms and should not be limited by the embodiments set forth here. On the contrary, these embodiments are provided to make the present disclosure more thorough and complete and to fully convey the scope of the present disclosure to those skilled in the art.

It should be understood that although the terms "first", "second" and "third" may be used to describe various information in this present disclosure, this information should not be limited to these terms. These terms are only used to distinguish the same type of information from each other. For example, without departing from the scope of the present disclosure, the first information can also be called the second information, and similarly, the second information can also be called the first information. Therefore, the features defined as "first" and "second" may include one or more of these features explicitly or implicitly. In the description of the present disclosure, the meaning of "multiple" is two or more, unless otherwise specified.

In the description of the present disclosure, it should be understood that terms such as “length”, “width”, “upper”, “lower”, “front”, “rear”, “left”, “right”, “vertical”, “horizontal”, “top”, “bottom”, “inside” and “outside” indicate orientations or positional relationships that are based on the orientations or positional relationships shown in the drawings, and are used for the convenience and simplicity of description, but do not indicate or imply that the device or element referred to must have a particular orientation, be constructed and operated in a particular orientation, and therefore, are not to be construed as limiting the present disclosure.

Unless otherwise expressly provided and qualified, the terms “installation”, “connection”, “link”, “fixing”, etc., are to be understood in a broad sense. For example, they could be a fixed connection or a removable connection, or a one-piece connection; could be a mechanical connection or an electrical connection; could be a direct connection or an indirect connection through an intermediary medium, could be a connection within two elements or an interaction between the two elements. For a person of ordinary skill in the art, the specific meaning of the above terms in the present disclosure may be understood based on the specific circumstances.

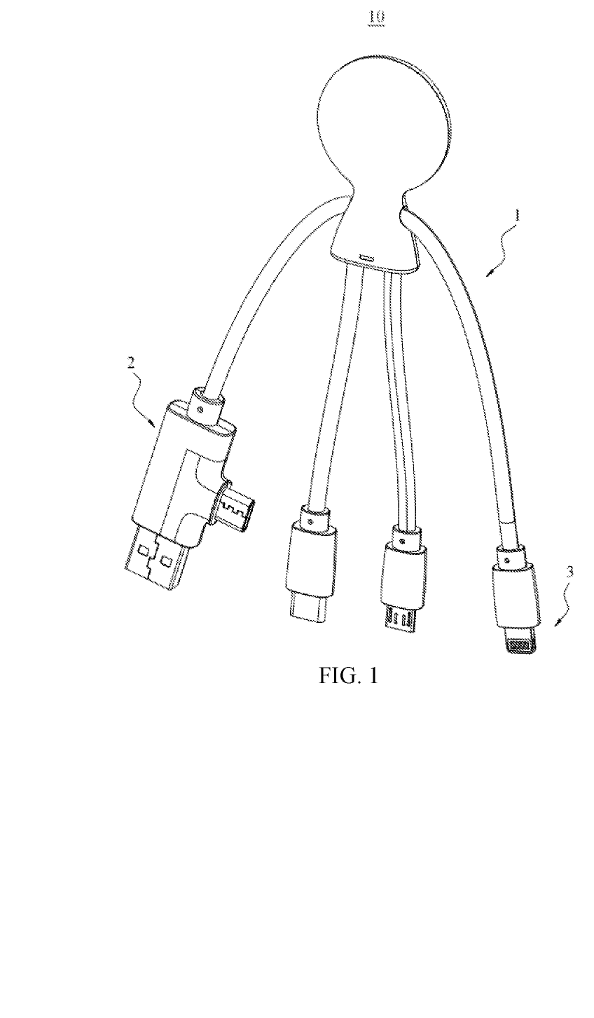

FIG. 1 shows a data cable 10 in some embodiments of the present disclosure, which is used to connect two ports that need to be connected, that is, two different ports can be connected through the data cable 10. Specifically, the data cable 10 can be connected between the mobile power supply and the mobile phone to charge the mobile phone. The data cable 10 can also be connected between the mobile phone and the notebook computer to realize data exchange between the mobile phone and the notebook computer.

As shown in FIG. 1, data cable 10 includes a wire 1, an input end 2, and an output end 3, and the input end 2 and the output end 3 are respectively arranged at both ends of the wire 1 to be electrically connected by the wire 1.

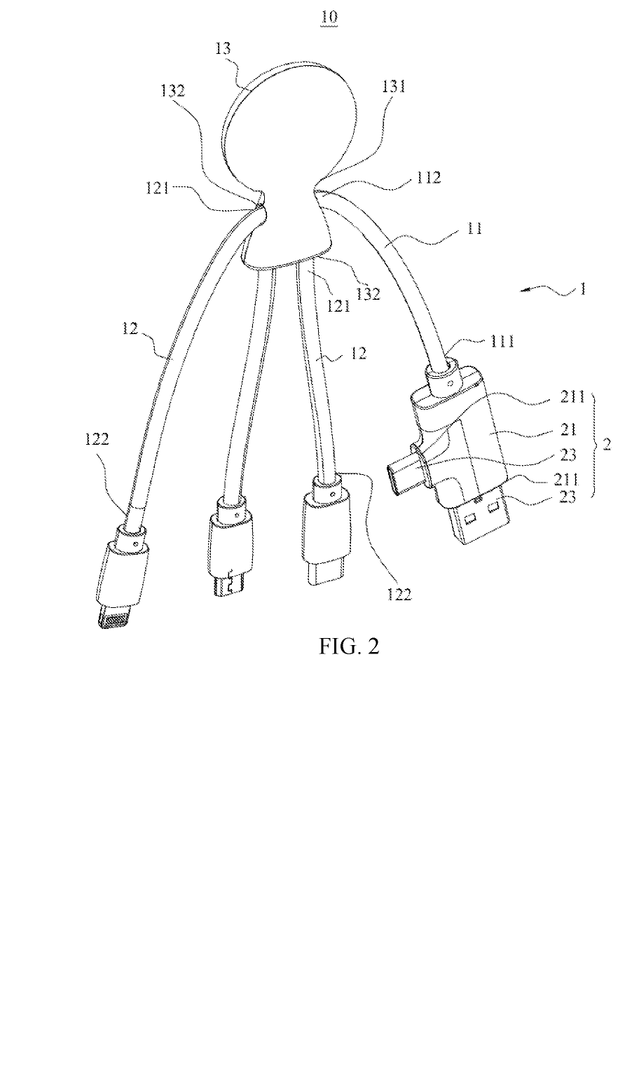

As shown in FIG. 2 to FIG. 7, the input end 2 includes a first outer housing 21, a Type-C first socket 22, at least one first plug 23, and a first circuit board 24. The Type-C first socket 22 and the at least one first plug 23 are electrically connected to the first circuit board 24 respectively, and the first outer housing 21 covers the Type-C first socket 22, the at least one first plug 23, and the first circuit board 24 respectively.

It is understandable that the first outer housing 21 can provide physical protection for internal electronic components against damage caused by daily wear and tear and accidental collisions. The Type-C first socket 22 is designed to accommodate an external Type-C plug therein (the external Type-C plug refers to a Type-C plug on a port that needs to be connected through the present disclosure, excluding the Type-C plug included in the present disclosure). The arrangement of the first plug 23 improves the compatibility of the data cable 10. The input terminal of the first line segment 11 is connected to the inside of the first outer housing 21 by reliable connection technology (such as welding or plug-in connector), which ensures the stable connection of each connection position. The first circuit board 24 is configured as the center of connection and control, which is not only directly connected with the Type-C first socket 22 to ensure the realization of high-speed data transmission and high-power charging functions, but also electrically connected with each of the first plugs 23, so that signals and power can be accurately distributed to the corresponding interfaces.

The Type-C first socket 22 and each of the first plugs 23 are arranged on the first outer housing 21. The first circuit board 24 is arranged in the first outer housing 21, and the Type-C first socket 22 and each of the first plugs 23 are electrically connected to the first circuit board 24.

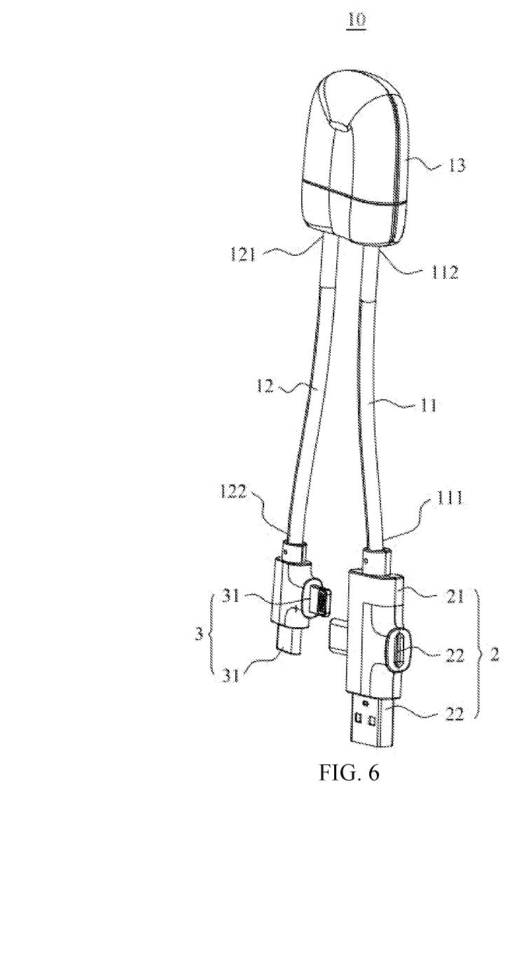

As shown in FIG. 6, the wire 1 includes a first line segment 11 and a second line segment 12, the first input terminal 111 of the first line segment 11 is connected to the input end 2, and the second input terminal 121 of the second line segment 12 is connected to the first output terminal 112 of the first line segment 11; the output end 3 includes a plurality of second plugs 31, at least two of the second plugs 31 have different plug specifications, and each of the second plugs 31 is connected to the second output terminal 122 of the second line segment 12.

Understandably, wire 1 only includes a first line segment 11 and a second line segment 12. In use, the current is transmitted to the first input terminal 111 of the first line segment 11 through the input end 2, then to the second input terminal 121 of the second line segment 12 through the first output terminal 112 of the first line segment 11, and then to one of the second plugs 31 or each of the second plugs 31 through the second output terminal 122 of the second line segment 12. In this way, products can be correspondingly matched with different interfaces only through a single second line segment 12, and a plurality of second line segments 12 are not required. It not only improves the universality of products, but also reduces the manufacturing cost of products.

As shown in FIG. 2 to FIG. 5, the output end 3 includes at least one second plug 31, which is connected to the wire 1, and the length of the effective connection path L1 between any one of the first plugs 23 and any one of the second plugs 31 is 5 cm to 25 cm.

It should be noted that the effective connection path L1 refers to each connection part from the first plug 23 to the second plug 31 to ensure the effective transmission of data and/or power. Configuring the effective connection path L1 to be 5cm to 25cm can provide the necessary flexibility, avoid the inconvenience caused by redundant wires, and meet various connection requirements in diverse application scenarios.

It should also be noted that the data cable of this present disclosure can provide seamless cross-device connection during short-distance connection and long-distance connection, which improves the convenience of use, given the problems faced by users such as different plug specifications and inconvenient carrying under the background of the popularization of the current Type-C interface. Specifically, the output end 3 of the present disclosure is configured as the second plug 31 with various plug specifications (such as Type-C, USB-A, Micro-USB, Lightning, etc.), thus ensuring wide compatibility. Users can quickly change or directly choose the appropriate plug specifications according to actual needs, without carrying many different types of long data cables, which greatly reduces the travel burden.

In the process of going out to use, such as in cafes, airports, or trains, it is often necessary to use a mobile power supply for charging mobile phones or other devices. At this time, the effective connection path length of the data cable is configured between 5 cm to 25 cm, it is very suitable for short-distance connection and avoids the inconvenience caused by long lines, such as excessive winding and sorting. The design of this short data cable is easy to carry, and at the same time, it can quickly connect mobile power supplies and devices to meet the demand for instant charging.

When users are in a home setting, they may encounter a situation where the charging socket is far away from the work area and the resting area. At this time, if the traditional long data cable is used, although the distance problem is solved, it is very complicated to replace different types of plugs frequently. The data cable of this present disclosure provides solutions, users can plug the Type-C data cable for long-distance connection into the Type-C first socket of the data cable, and then connect to different devices through the second plugs of different specifications on the data cable. In this way, there is no need to carry data cables with various plug types and lengths, which greatly simplifies the process of charging and data transmission and improves the use efficiency and convenience. To sum up, the data cable of the present disclosure takes into account the short-distance and long-distance connection requirements and also takes into account the compatibility of different device interfaces, so that users can easily cope with various charging and data transmission scenarios whether they are out or at home, without frequently replacing the data cable or carrying multiple adapters. This not only reduces the user's burden but also improves the user experience, making it an ideal data cable product for portable and home use.

Further, as shown in FIG. 2 to FIG. 5, the output end 3 includes a plurality of second plugs 31, the plug specifications of at least two second plugs 31 are different, and each of the second plugs 31 is arranged in the second output terminal 122 of each of the second line segments 12 in one-to-one correspondence.

The output end 3 is configured with a plurality of second plugs 31, and at least two second plugs 31 are configured with different specifications (for example, including different types of USB interfaces or other special interfaces) to meet the connection requirements of different devices. Each of the second plug 31 is installed on each of the second output terminals 122 respectively so that each of the second line segments 12 can adapt to different device interfaces according to actual application requirements. This design allows the user to easily select or replace the appropriate second plug according to the interface type of their device, without carrying extra data cables, which greatly improves portability and practicality.

As shown in FIG. 2 to FIG. 5, the wire 1 includes a first line segment 11 and at least one second line segment 12, and the second input terminal 121 of each of the second line segment 12 is connected to the first output terminal 112 of the first line segment 11. The wire 1 further includes a switching member 13, the first output terminal 112 is connected with the switching member 13, and each of the second input terminals 121 is connected with the switching member 13.

Understandably, the first line segment 11 is used to further transmit the data and/or current input via the input end 2 to the second line segment 12, and then the second line segment 12 is used to further transmit the data and/or current to the output end 3 and be output by the data and/or current.

The switching member 13 is located at the intersection of the first line segment 11 and each second line segment 12, and plays the role in undertaking. The end of the first line segment 11, that is, the first output terminal 112, is tightly and firmly connected to the switching member 13. At the same time, the second input terminal 121 of each of the second line segments 12 is also connected with the switching member 13. This design enables a plurality of second line segments to be gathered together in an orderly and centralized manner, thus avoiding the disorder of cables.

It should be noted that the switching member 13 can be configured to be made of high-strength plastic or metal. The outline of the switching member 13 can be flexibly adjusted according to actual use requirements or design requirements. Of course, the number of the switching members 13 can be configured as one or more, and wires for connection are arranged among the switching members 13, and the wires in this part are used for connecting the first line segment 11 and the second line segment 12 correspondingly.

As shown in FIG. 2 to FIG. 4, the switching member 13 is provided with an intermediate input position 131 and a plurality of intermediate output positions 132, the first output terminal 112 is connected to the intermediate input position 131, and each of the second input terminals 121 is connected to each of the intermediate output positions 132 in one-to-one correspondence. The intermediate input position 131 is respectively connected with each of the intermediate output positions 132 in a straight line to form a plurality of intermediate paths L2 and any of the intermediate paths L2 can be independently used to form at least a part of the effective connection path L1.

Understandably, the intermediate input position 131 of the switching member 13 is configured to receive the connection from the first output terminal 112 of the first line segment 11. The intermediate output positions 132 are all configured to fix the second input terminals 121 of the second line segments 12. The position of the intermediate input position 131 and each of the positions of the intermediate output positions 132 can be set flexibly.

Several intermediate paths L2 are formed between the intermediate input position 131 and each of the intermediate output positions 132 through a straight line connection, and each of the intermediate paths L2 serves as an independent path for data and/or power transmission, and its design enables any one of the intermediate paths L2 to independently or partially form the final effective connection path L1. Accordingly, the effective connection path L1, which is composed entirely or partially of any the intermediate path L2, should have a length that falls within the range of 5 cm to 25 cm, to prevent the product from being unable to meet the short-distance connection requirements due to the excessively long intermediate path L2.

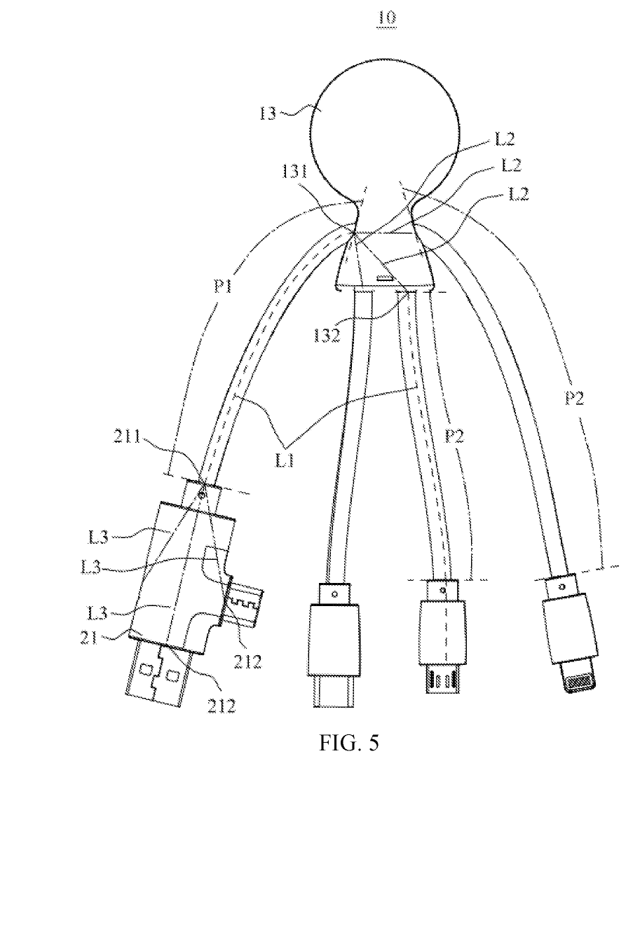

As shown in FIG. 5, in some embodiments of the data cable 10, the length of the part of the first line segment 11 exposed between the switching member 13 and the first outer housing 21 (this part is shown by P1 in FIG. 5) is 3 cm to 12 cm.

Understandably, the part of the first line segment 11 exposed between the switching member 13 and the first outer housing 21 is the effective connection length, and the exposed part is included in the effective connection path. Correspondingly, when the external encapsulated part or external fixed part of each of the connectors is different in size specification and matching position with the first line segment 11, the length of the part of the first line segment 11 exposed between the switching member 13 and the first outer housing 21 will also change. By employing the content of the present embodiment, the deformable and bendable characteristic of the first line segment 11 itself can be utilized as much as possible, so that the product can be flexibly adjusted in angle to be connected to a predetermined position.

As shown in FIG. 5, the length of at least part of the second line segment 12 exposed between the switching member and the second plug 31 (this part is shown by P2 in FIG. 5) is 3 cm to 12 cm.

Understandably, referring to the content of the aforementioned embodiments, through the content of the present embodiment, the deformable and bendable characteristic of the second line segment 12 itself can be utilized as much as possible, so that the product can be flexibly adjusted in angle to be connected to a predetermined position.

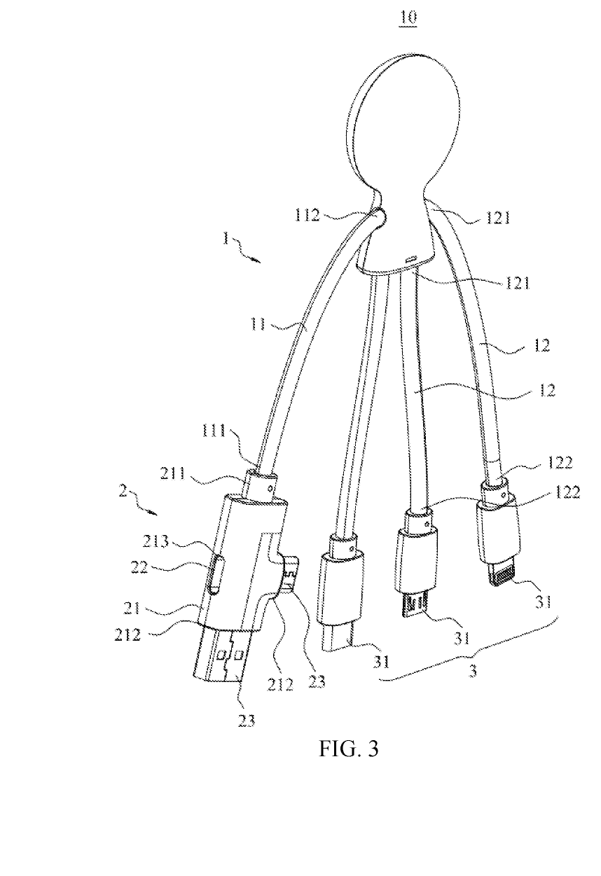

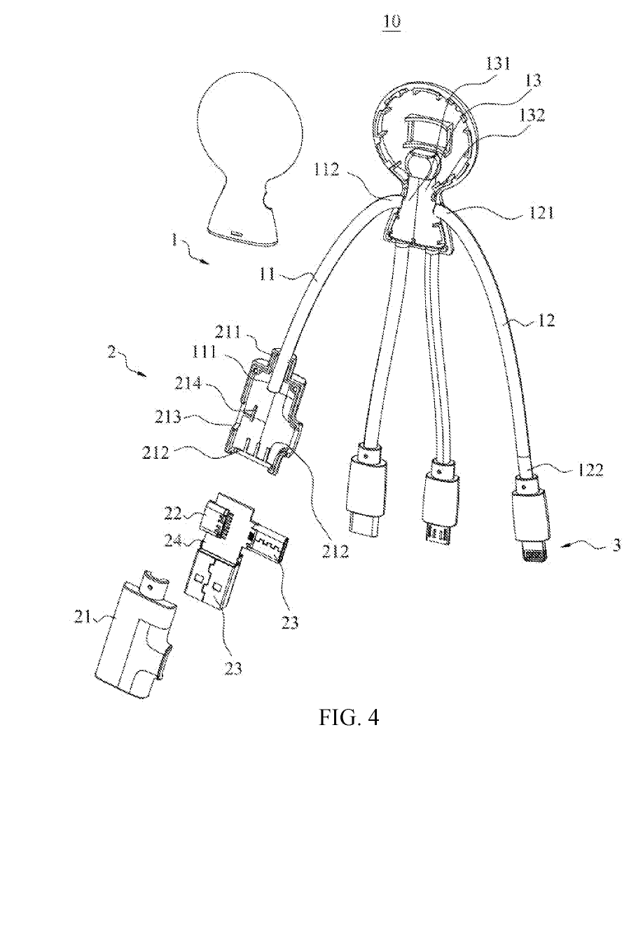

As shown in FIG. 3 and FIG. 4, in some embodiments of the data cable 10, the lengths of the second line segments 12 are all equal. As can be understood, configuring the lengths of all the second line segments 12 to be the same makes it possible for a user to arrange and arrange cables more intuitively, particularly, when a plurality of devices need to be connected or cables need to be stored simultaneously, avoiding confusion and inconvenience caused by different lengths of cables.

In other embodiments of the data cable 10, the length of the first line segment 11 and the length of each of the second line segments 12 are equal. Understandably, when the lengths of the first line segment 11 and each of the second line segments 12 are the same, the whole data cable system exhibits good symmetry, which improves the user's comfort. At the same time, in the process of production and processing, it can avoid the increase of production cost caused by the diversification of specifications of too many spare parts.

As shown in FIG. 3 and FIG. 4, in some embodiments of the data cable 10, the length of the first line segment 11 is 4 cm to 14 cm.

It should be noted that the length of the first line segment 11 refers to the overall line length of the first line segment 11, including the visible part exposed to the outside and the part inserted in the installation position to form the insertion amount (if any, it includes).

As shown in FIG. 3 and FIG. 4, in some embodiments of the data cable 10, at least part of the second line segment 12 has a length of 4 cm to 14 cm.

It should be noted that the length of the second line segment 12 refers to the overall line length, including the visible part exposed to the outside and the part inserted in the installation position to form the insertion amount (if any, it includes).

Specifically, the first plug 23 includes a USB plug and/or a Type-C plug. Understandably, because the Type-C interface has become the standard configuration of many modern electronic devices, including smartphones, tablet computers, notebook computers, etc., the Type-C plug included in the first plug 23 ensures seamless connection with the latest technology devices. In addition, if the first plug 23 is configured to include a USB plug, the compatibility of the product with old or non-Type-C interface devices is guaranteed, so that the product can be widely used in various electronic devices, regardless of the old or new, without additional adapters, and the versatility of the data cable is improved.

Specifically, the Type-C first socket 22 includes a Type-C socket.

As shown in FIG. 2 to FIG. 5, in some embodiments of the data cable 10, the first outer housing 21 is provided with a first output position 211 and a plurality of first input positions 212, and the first input terminal 111 is connected to the first output position 211, and the Type-C first sockets 22 and each of the first plugs 23 are arranged in each of the first input positions 212 in one-to-one correspondence;

The first output position 211 is respectively connected with each of the first input positions 212 in a straight line to form a plurality of first paths L3, and any one of the first paths L3 can be independently used to form at least a part of the effective connection path L1.

Understandably, the first outer housing 21 may be a housing common in the related art, which may be made of materials common in the prior art.

It should be noted that any one of the first input positions 212 is connected to an external port, and the external port will be output through the first output position 211. The first path L3 formed by the connection in a straight line of any one of the first input positions 212 and the first output position 211 can be independently used to form a part of the effective connection path L1. Of course, the L1 formed by any one of the L3 is within a predetermined length range (5cm to 25cm), to avoid the effective connection path L1 from exceeding the predetermined length range of L1 due to the excessive length of the portion L3, and ensure that the use of any one of the first input positions 212 can meet the short-distance connection requirements of users.

As shown in FIG. 4, in some embodiments of the data cable 10, the first outer housing 21 is provided with a seat hole 213, the Type-C first socket 22 is arranged in the seat hole 213, and two T-shaped positioning pieces 214 are arranged in the first outer housing 21, and the two T-shaped positioning pieces 214 respectively abut against the Type-C first socket 22 from two opposite sides.

Understandably, the seat hole 213 formed in the first outer housing 21 is used to provide a mounting position for the Type-C first socket 22. The stability of the Type-C first socket 22 is improved, and the phenomenon of displacement or looseness caused by external force during use is avoided. Two T-shaped positioning pieces 214 are respectively arranged inside the first outer housing 21 and located at both sides of the Type-C first socket 22 to clamp and fix the socket. The T-shaped design is unique in that it can provide support from both sides of the socket, effectively preventing the socket from rotating or falling off when it is subjected to lateral tension or torsion, and greatly enhancing the durability and stability of the interface.

Further, the T-shaped positioning piece 214 may be configured to be disposed of on the first outer housing 21 by integral molding, thereby preventing the T-shaped positioning piece 214 from detaching from the first outer housing 21.

As shown in FIG. 2 to FIG. 5, in some embodiments of the data cable 10, each of the second plugs 31 includes at least two of a second Type-C plug, a second Lightning plug, and a second Micro-USB connector.

Understandably, through the content of this kind of embodiment, it can be ensured that each of the second plugs 31 can correspondingly adapt to devices with at least two interfaces, thus ensuring the universality of product plugging.

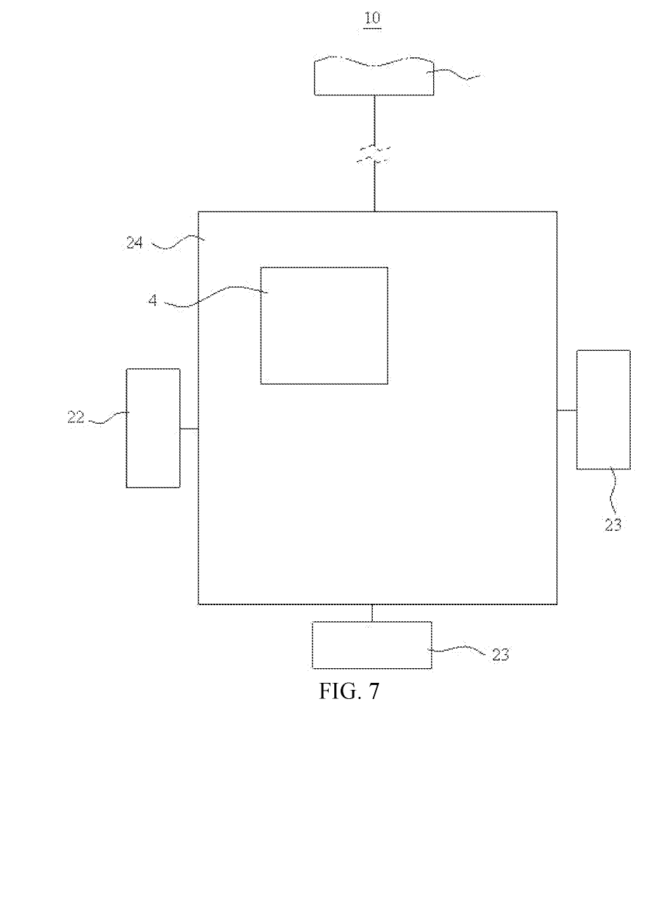

As shown in FIG. 7, in some embodiments of the data cable 10, the data cable 10 includes a control circuit 4, which is connected to the Type-C first socket 22, and the control circuit 4 is used to cut off the Type-C plug in the second plug 31 after the plug is correspondingly inserted in the Type-C first socket 22.

Understandably, the data cable 10 is internally provided with a circuit structure, and the circuit structure is directly connected with the Type-C first socket 22, to monitor the plugging state in the socket in real-time. When it is detected that an external device plug is connected to the inside of the Type-C first socket 22, the control circuit immediately starts the intelligent judgment logic, aiming at optimizing and protecting the whole data transmission system.

In actual use, once the Type-C first socket 22 is occupied (that is, an external Type-C plug is inserted), the control circuit will automatically cut off the power supply and data transmission path of the Type-C plug in the second plug 31. The purpose of this design is to avoid potential current loops or data collisions and ensure the system security and stability of data transmission when multiple interfaces are used simultaneously.

The present disclosure has the following beneficial effects:

The present disclosure relates to a data cable, which can be used by users for short-distance connections, and can be further connected with different plugs based on short-distance connections. On the other hand, when the user uses the Type-C data cable for long-distance connection, the plug of the Type-C data cable can be plugged into the Type-C first socket of the present disclosure, then further connection can be made through the second plug with different specifications, thus preventing the user from repeatedly replacing the data cable for a long-distance connection due to different plug use requirements. Users do not need to carry data cables with different plug types and different plug lengths when traveling.

In this way, the product can adapt to different application requirements, improve the universality of the product, and also improve the convenience of use of the product.

The scheme of the present disclosure has been described in detail above concerning the attached drawings. In the above-mentioned embodiments, the description of each embodiment has its emphasis. For the parts that are not described in detail in one embodiment, please refer to the relevant descriptions of other embodiments. Those skilled in the art should also know that the actions and modules involved in the specification are not necessarily necessary for the present disclosure. In addition, it can be understood that the steps in the method of the embodiment of the present disclosure can be adjusted, merged, and deleted in sequence according to actual needs, and the modules in the device of the embodiment of the present disclosure can be merged, divided and deleted according to actual needs.

Various embodiments of the present disclosure have been described above, and the above description is exemplary, not exhaustive, and is not limited to the disclosed embodiments. Many modifications and changes will be obvious to those skilled in the art without departing from the scope and spirit of the illustrated embodiments. The terminology used herein is chosen to best explain the principles of various embodiments, practical application, or improvement of technology in the market, or to enable other ordinary people in the technical field to understand various embodiments disclosed herein.

What is claimed is:

1. A data cable, comprising an input end, an output end, and a wire connecting the input end and the output end, wherein the input end comprises a first outer housing, at least one Type-C first socket, at least one first plug, and a first circuit board, the Type-C first socket and each of the first plugs are electrically connected to the first circuit board respectively, the first outer housing covers the Type-C first socket, the at least one first plug, and the first circuit board respectively.

2. The data cable according to claim 1, wherein the wire comprises a first line segment and a second line segment, the first input terminal of the first line segment is connected to the input end, and the second input terminal of the second line segment is connected to the first output terminal of the first line segment; and
the output end comprises a plurality of second plugs, at least two of the second plugs have different plug specifications, and each of the second plugs is connected to the second output terminal of the second line segment.

3. The data cable according to claim 1, wherein the output end comprises at least one second plug which is connected to the wire, and the length of an effective connection path between any one of the first plugs and any one of the second plugs is 5 cm to 25 cm.

4. The data cable according to claim 3, wherein the wire comprises a first line segment and at least one second line segment, and the second input terminal of each of the second line segments is connected to the first output terminal of the first line segment; and
the wire further comprises a switching member, the first output terminal is connected with the switching member, and each of the second input terminals is connected with the switching member.

5. The data cable according to claim 4, wherein the switching member is provided with an intermediate input position and a plurality of intermediate output positions, the first output terminal is connected to the intermediate input position, and each of the second input terminals is connected to each of the intermediate output positions in one-to-one correspondence; and
the intermediate input position is respectively connected with each of the intermediate output positions in a straight line to form a plurality of the intermediate paths, any of the intermediate paths can be independently used to form at least a part of the effective connection path.

6. The data cable according to claim 4, wherein the length of each of the second line segments is equal; and/or
the length of the first line segment is equal to the length of each of the second line segments.

7. The data cable according to claim 4, wherein the length of the first line segment is 4 cm to 14 cm; and/or
the length of at least one second line segment is 4 cm to 14 cm; and/or
the length of the part of the first line segment exposed between the switching member and the first outer housing is 3 cm to 12 cm; and/or
the length of the part of at least one second line segment exposed between the switching member and the second plug is 3 cm to 12 cm.

8. The data cable according to claim 3, wherein the first outer housing is provided with a first output position and a plurality of first input positions, the first input terminal is connected to the first output position, the Type-C first socket and each of the first plugs are arranged in each of the first input positions in one-to-one correspondence;
the first output position is respectively connected with each of the first input positions in a straight line to form a plurality of first paths, and any one of the first paths can be independently used to form at least a part of the effective connection path.

9. The data cable according to claim 4, wherein the first outer housing is provided with a seat hole, the Type-C first socket is arranged in the seat hole, two T-shaped positioning pieces are arranged in the first outer housing, and the two T-shaped positioning pieces respectively abut against the Type-C first socket from two opposite sides; and/or
the output end comprises a plurality of second plugs, at least two of the second plugs have different plug specifications, and each of the second plugs is arranged in the second output terminal of each of the second line segments in one-to-one correspondence.

10. The data cable according to claim 1, wherein the first plug comprises a USB plug and/or a Type-C plug; and/or
the Type-C first socket comprises a Type-C socket.
